(19) United States
(12) Patent Application Publication
(10) Pub. No.: US 2016/0014307 A1
(43) Pub. Date: Jan. 14, 2016

(54) IMAGE CAPTURING MODULE HAVING A BUILT-IN FLEXIBLE DUSTPROOF STRUCTURE

(71) Applicant: Larview Technologies Corp., Taoyuan County (TW)

(72) Inventors: KUO-HAO PENG, HSINCHU CITY (TW); PO-CHIH HSU, HSINCHU COUNTY (TW)

(21) Appl. No.: 14/330,334

(22) Filed: Jul. 14, 2014

(51) Int. Cl. H04N 5/225; H04N 3/06; G03B 13/34

(52) U.S. Cl. CPC H04N 5/2252; G03B 13/34; H04N 3/06

(57) ABSTRACT

An image capturing module having a built-in flexible dustproof structure includes an image sensing unit, a housing frame, an actuator structure and a flexible ring. The image sensing unit includes a carrier substrate and an image sensing chip. The housing frame is disposed on the carrier substrate to surround the image sensing chip. The actuator structure is disposed on the housing frame. The actuator structure includes a lens holder disposed on the housing frame and a movable lens assembly movably disposed inside the lens holder. The flexible ring is disposed around an outer perimeter surface of the movable lens assembly and abutted against an inner surrounding surface of the lens holder. Whereby, the flexible ring is surroundingly disposed between the inner surrounding surface of the lens holder and the outer perimeter surface of the movable lens assembly to form the built-in flexible dustproof structure.

### BACKGROUND OF THE INVENTION

1. Field of the Invention

The instant disclosure relates to an image capturing module, and more particularly to an image capturing module having a built-in flexible dustproof structure.

2. Description of Related Art

Recently, it becomes more and more popular for portable devices such as mobile phones or PDA to be equipped with an imaging module. Furthermore, since the market requires these portable devices to have more powerful functions and smaller sizes, it is necessary for the imaging module to generate high quality pictures and to be of small size accordingly. One improvement of picture quality is to increase the number of pixel. The pixel number of an imaging module has already increased from the VGA-level 30 pixels to 2, 5, 8, 13 or even 41 million pixels, which is now common in the market. Another improvement lies in the definition of the image. Thus, the imaging module of a portable device also develops from a fixed-focus mode to auto-focus mode or even optical zoom mode.

The auto-focus mode employs the principle of moving the lens in the imaging module suitably according to various distances of targets, whereby the optical image of the desired target can be focused correctly on an image sensor so as to generate a clear image. The common ways of activating the lens to move in the imaging module include activating by a stepping motor, piezoelectric motor and voice coil motor (VCM). However, there is no any dustproof design for the prior imaging module.

### SUMMARY OF THE INVENTION

One aspect of the instant disclosure relates to an image capturing module having a built-in flexible dustproof structure.

One of the embodiments of the instant disclosure provides an image capturing module having a built-in flexible dustproof structure, comprising: an image sensing unit, a housing frame, an actuator structure and a flexible ring. The image sensing unit includes a carrier substrate and an image sensing chip disposed on the carrier substrate and electrically connected to the carrier substrate. The housing frame is disposed on the carrier substrate to surround the image sensing chip. The actuator structure is disposed on the housing frame and above the image sensing chip, wherein the actuator structure includes a lens holder disposed on the housing frame and a movable lens assembly movably disposed inside the lens holder. The flexible ring is disposed around an outer perimeter surface of the movable lens assembly and abutted against an inner surrounding surface of the lens holder, wherein both the flexible ring and the movable lens assembly are concurrently moved inside the lens holder. Whereby, the flexible ring is surroundingly disposed between the inner surrounding surface of the lens holder and the outer perimeter surface of the movable lens assembly to form the built-in flexible dustproof structure.

Another one of the embodiments of the instant disclosure provides an image capturing module having a built-in flexible dustproof structure, comprising: an image sensing unit, a housing frame, an actuator structure and a flexible ring. The image sensing unit includes a carrier substrate and an image sensing chip disposed on the carrier substrate and electrically connected to the carrier substrate. The housing frame is disposed on the carrier substrate to surround the image sensing chip. The actuator structure is disposed on the housing frame and above the image sensing chip, wherein the actuator structure includes a lens holder disposed on the housing frame and a movable lens assembly movably disposed inside the lens holder, and the lens holder includes a surrounding movable member movably disposed therein. The flexible ring is disposed around an outer perimeter surface of the movable lens assembly and abutted against an inner surrounding surface of the surrounding movable member of the lens holder. More precisely, the movable lens assembly and the flexible ring are fixed inside the surrounding movable member through at least two separate bonding glue, and the movable lens assembly is movably disposed inside the lens holder through the surrounding movable member. Whereby, the flexible ring is surroundingly disposed between the inner surrounding surface of the surrounding movable member of the lens holder and the outer perimeter surface of the movable lens assembly to form the built-in flexible dustproof structure.

Yet another one of the embodiments of the instant disclosure provides an image capturing module having a built-in flexible dustproof structure, comprising: an image sensing unit, a housing frame and an actuator structure. The image sensing unit includes a carrier substrate and an image sensing chip disposed on the carrier substrate and electrically connected to the carrier substrate. The housing frame is disposed on the carrier substrate to surround the image sensing chip. The actuator structure is disposed on the housing frame and above the image sensing chip, wherein the actuator structure includes a lens holder disposed on the housing frame and a movable lens assembly movably disposed inside the lens holder, the movable lens assembly has a flexible ring surroundingly fixed on an outer perimeter surface thereof by double injection molding and abutted against an inner surrounding surface of the lens holder, and both the flexible ring and the movable lens assembly are concurrently moved inside the lens holder.

Therefore, because the flexible ring is disposed around the outer perimeter surface of the movable lens assembly and abutted against the inner surrounding surface of the lens holder, the flexible ring can be surroundingly disposed between the inner surrounding surface of the lens holder and the outer perimeter surface of the movable lens assembly to form the built-in flexible dustproof structure. Alternatively, because the movable lens assembly has a flexible ring formed by double injection molding (over-molding), the flexible ring can be surroundingly fixed on the outer perimeter surface of the movable lens assembly and abutted against the inner surrounding surface of the lens holder to form the built-in flexible dustproof structure. Whereby, when the external dust passes through the gap between the inner surrounding surface of the lens holder or the surrounding movable member and the outer perimeter surface of the movable lens assembly to get into the actuator structure, the external dust is obstructed by the flexible ring that is surroundingly disposed between the inner surrounding surface of the lens holder and the outer perimeter surface of the movable lens assembly.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows an exploded, schematic view of the image capturing module having a built-in flexible dustproof structure according to the first embodiment of the instant disclosure;

FIG. 2 shows an assembled, schematic view of the image capturing module having a built-in flexible dustproof structure according to the first embodiment of the instant disclosure;

FIG. 3 shows another assembled, schematic view of the image capturing module having a built-in flexible dustproof structure according to the first embodiment of the instant disclosure;

FIG. 4 shows an exploded, schematic view of the image capturing module having a built-in flexible dustproof structure according to the second embodiment of the instant disclosure;

FIG. 5 shows an assembled, schematic view of the image capturing module having a built-in flexible dustproof structure according to the second embodiment of the instant disclosure;

FIG. 6 shows another assembled, schematic view of the image capturing module having a built-in flexible dustproof structure according to the second embodiment of the instant disclosure;

FIG. 7 shows an exploded, schematic view of the image capturing module having a built-in flexible dustproof structure according to the third embodiment of the instant disclosure;

FIG. 8 shows an assembled, schematic view of the image capturing module having a built-in flexible dustproof structure according to the third embodiment of the instant disclosure; and

FIG. 9 shows another assembled, schematic view of the image capturing module having a built-in flexible dustproof structure according to the third embodiment of the instant disclosure.

### DETAILED DESCRIPTION OF THE PREFERRED EMBODIMENTS

The embodiments of “an image capturing module having a built-in flexible dustproof structure” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

### First Embodiment

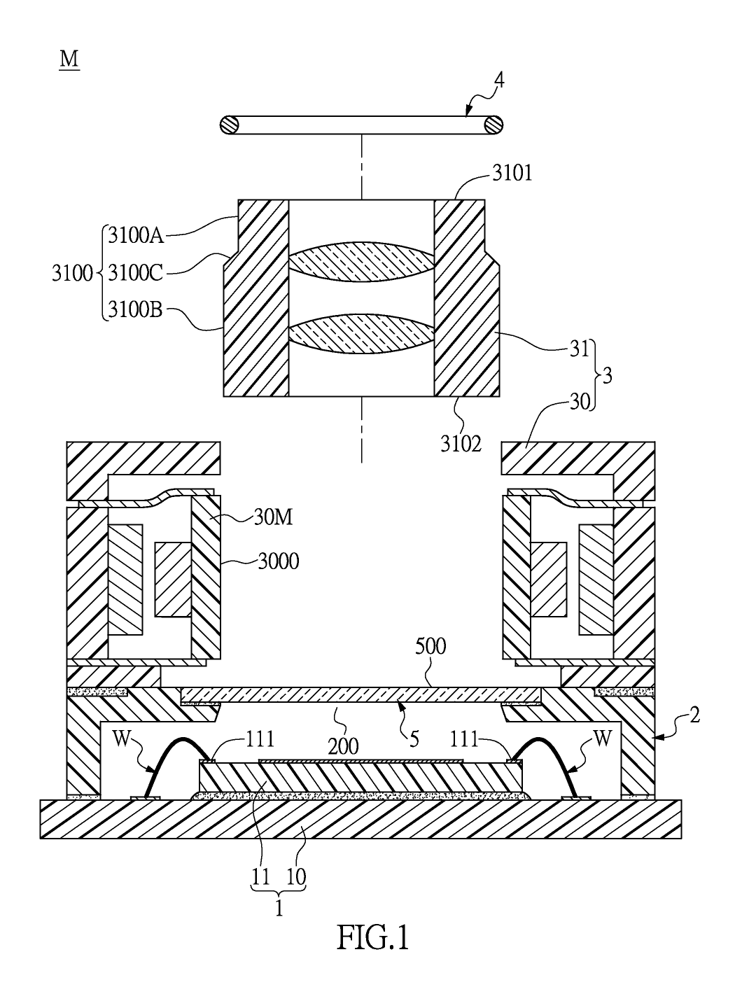

Referring to FIG. 1 to FIG. 3, the first embodiment of the instant disclosure provides an image capturing module M having a built-in flexible dustproof structure, comprising: an image sensing unit 1, a housing frame 2, an actuator structure 3 and a flexible ring 4.

First, as shown in FIG. 1, the image sensing unit 1 includes a carrier substrate 10 (or a carrying substrate) and an image sensing chip 11 disposed on the carrier substrate 10 and electrically connected to the carrier substrate 10. For example, the image sensing chip 11 may be a CMOS (Complementary Metal-Oxide-Semiconductor) image sensing chip, and the image sensing chip 11 can be adhesively disposed on the carrier substrate 10 through any type of adhesive material (not labeled) such as UV adhesive glue, thermosetting glue or curing glue applied to oven etc. In addition, the carrier substrate 10 may be a circuit substrate having a plurality of conductive pads (not labeled) disposed on the top surface of the circuit substrate, and the image sensing chip 11 has a plurality of conductive pads 111 disposed on the top surface of the image sensing chip 11. Each conductive pad 111 of the image sensing chip 11 can be electrically connected to the corresponding conductive pad (not labeled) of the carrier substrate 10 through a corresponding conductive wire W, thus the image sensing chip 11 can be electrically connected with the carrier substrate 10 through the conductive wires W.

Moreover, as shown in FIG. 1, the housing frame 2 is disposed on the carrier substrate 10 to surround the image sensing chip 11. The actuator structure 3 is disposed on the housing frame 2 and above the image sensing chip 11, and the actuator structure 3 includes a lens holder 30 disposed on the housing frame 2 and a movable lens assembly 31 movably disposed inside the lens holder 30. For example, the housing frame 2 can be adhesively disposed on the carrier substrate 10 through any type of adhesive material (not labeled) such as UV adhesive glue, thermosetting glue or curing glue applied to oven etc., and the lens holder 30 also can be adhesively disposed on the housing frame 2 through any type of adhesive material (not labeled) such as UV adhesive glue, thermosetting glue or curing glue applied to oven etc, and the movable lens assembly 31 may be an optical lens group that is composed of a plurality of optical lenses (not labeled). In addition, it is worth mentioning that the actuator structure 3 may be a voice coil motor actuator, but the voice coil motor actuator used in the first embodiment is merely an example and is not meant to limit the instant disclosure.

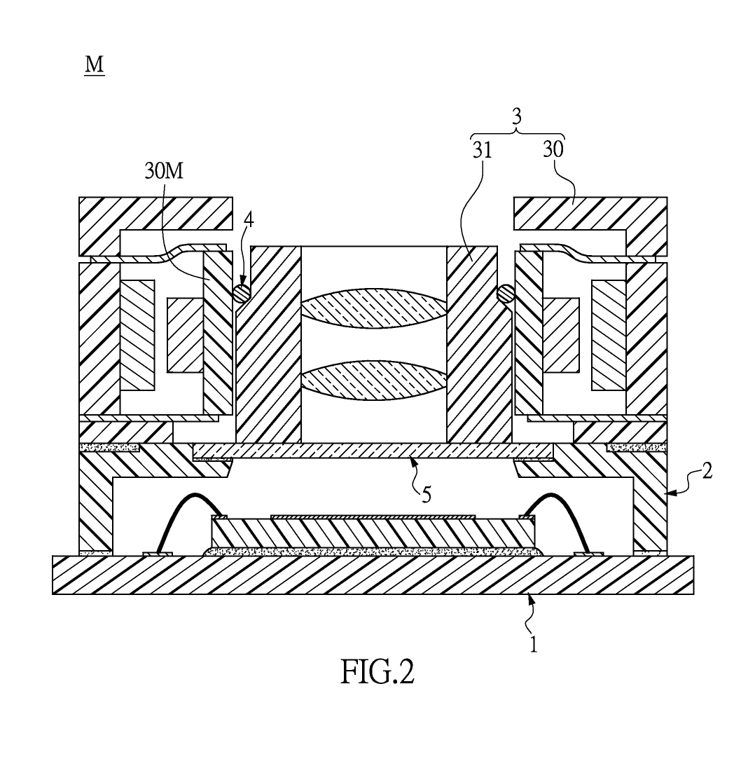

Furthermore, referring to FIG. 1 and FIG. 2, when the flexible ring 4 is disposed around an outer perimeter surface 3100 of the movable lens assembly 31 and abutted against an inner surrounding surface 3000 of the lens holder 30, the flexible ring 4 can follow the movable lens assembly 31 to move inside the lens holder 30 (i.e., both the flexible ring 4 and the movable lens assembly 31 can be concurrently moved inside the lens holder 30), thus the movable lens assembly 31 is still movable due to the flexible ring 4. In other words, when the movable lens assembly 31 is placed inside the lens holder 30 and then the flexible ring 4 is disposed around the outer perimeter surface 3100 of the movable lens assembly 31 and abutted against the inner surrounding surface 3000 of the lens holder 30, the flexible ring 4 is movably and surroundingly disposed between the inner surrounding surface 3000 of the lens holder 30 and the outer perimeter surface 3100 of the movable lens assembly 31 to form the built-in flexible dustproof structure. For example, the flexible ring 4 may be a O-ring made of rubber material, and both the inner surrounding surface 3000 of the lens holder 30 and the outer perimeter surface 3100 of the movable lens assembly 31 are thread surfaces or threadless (or unthreaded) surfaces (i.e., without any thread or screw on the inner surrounding surface 3000 and the outer perimeter surface 3100).

Besides, as shown in FIG. 1, the image capturing module M further comprises an optical filter 5 disposed on the housing frame 2 and between the image sensing chip 11 and the movable lens assembly 31. In addition, the housing frame 2 has a top opening 200 disposed on the top side thereof and between the image sensing chip 11 and the movable lens assembly 31, and the top opening 200 of the housing frame 2 is enclosed by the optical filter 5. Moreover, referring to FIG. 1 and FIG. 2, when the movable lens assembly 31 is placed inside the lens holder 30, the movable lens assembly 31 can be directly disposed on the top surface 500 of the optical filter 5, thus the bottom side 3102 of the movable lens assembly 31 can directly contact the top side 500 of the optical filter 5.

More precisely, as shown in FIG. 1, the outer perimeter surface 3100 of the movable lens assembly 31 can be divided into a first surrounding surface 3100A adjacent to the top side 3101 of the movable lens assembly 31, a second surrounding surface 3100B adjacent to the bottom side 3102 of the movable lens assembly 31, and a third surrounding surface 3100C (such as a surrounding inclined surface) connected between the first surrounding surface 3100A and the second surrounding surface 3100B, but it is merely an example and is not meant to limit the instant disclosure. Referring to FIG. 1 and FIG. 2, when the movable lens assembly 31 is placed inside the lens holder 30 and then the flexible ring 4 is disposed around the first surrounding surface 3100A and abutted against the third surrounding surface 3100C, the flexible ring 4 is surroundingly disposed between the inner surrounding surface 3000 of the lens holder 30 and the outer perimeter surface 3100 of the movable lens assembly 31 to form the built-in flexible dustproof structure.

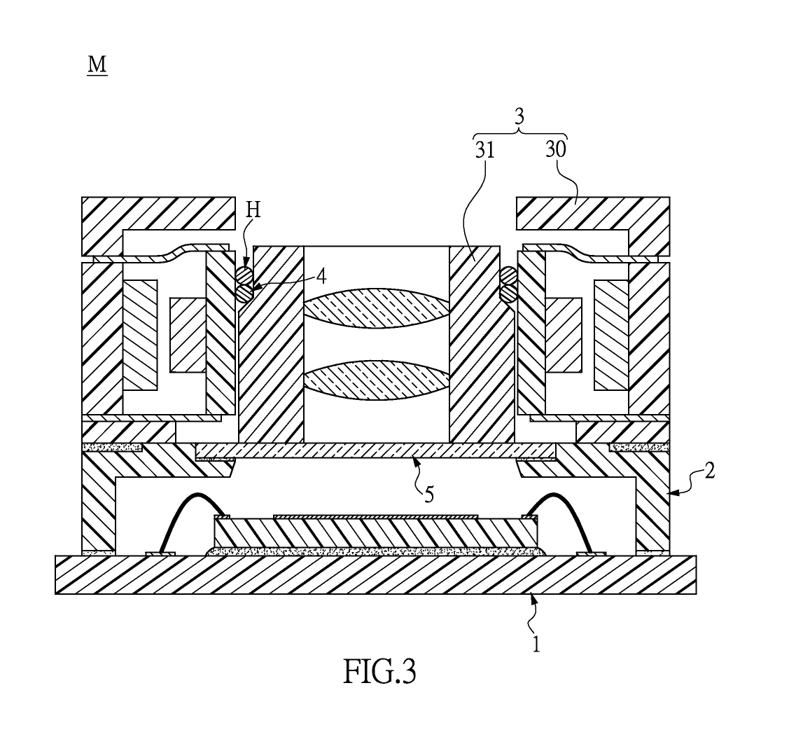

More precisely, referring to FIG. 1 to FIG. 3, the lens holder 30 includes a surrounding movable member 30M movably disposed therein. When the movable lens assembly 31 is placed inside the lens holder 30 and then the flexible ring 4 is disposed around the outer perimeter surface 3100 of the movable lens assembly 31 and abutted against the inner surrounding surface 3000 of the surrounding movable member 30M of the lens holder 30, the flexible ring 4 is surroundingly disposed between the inner surrounding surface 3000 of the surrounding movable member 30M of the lens holder 30 and the outer perimeter surface 3100 of the movable lens assembly 31 to form the built-in flexible dustproof structure. As shown in FIG. 3, when the movable lens assembly 31 is upwardly or downwardly moved to a predetermined correction position, the movable lens assembly 31 and the flexible ring 4 can be fixed inside the surrounding movable member 30M through at least two separate bonding glue H, thus the movable lens assembly 31 can be movably disposed inside the lens holder 30 through the surrounding movable member 30M. For example, both the inner surrounding surface 3000 of the surrounding movable member 30M of the lens holder 30 and the outer perimeter surface 3100 of the movable lens assembly 31 are thread surfaces or threadless (or unthreaded) surfaces (i.e., without any thread or screw on the inner surrounding surface 3000 and the outer perimeter surface 3100).

Whereby, when the external dust passes through the gap between the inner surrounding surface 3000 of the lens holder 30 or the surrounding movable member 30M and the outer perimeter surface 3100 of the movable lens assembly 31 to get into the actuator structure 3, the external dust is obstructed by the flexible ring 4 that is surroundingly disposed between the inner surrounding surface 3000 of the lens holder 30 and the outer perimeter surface 3100 of the movable lens assembly 31.

### Second Embodiment

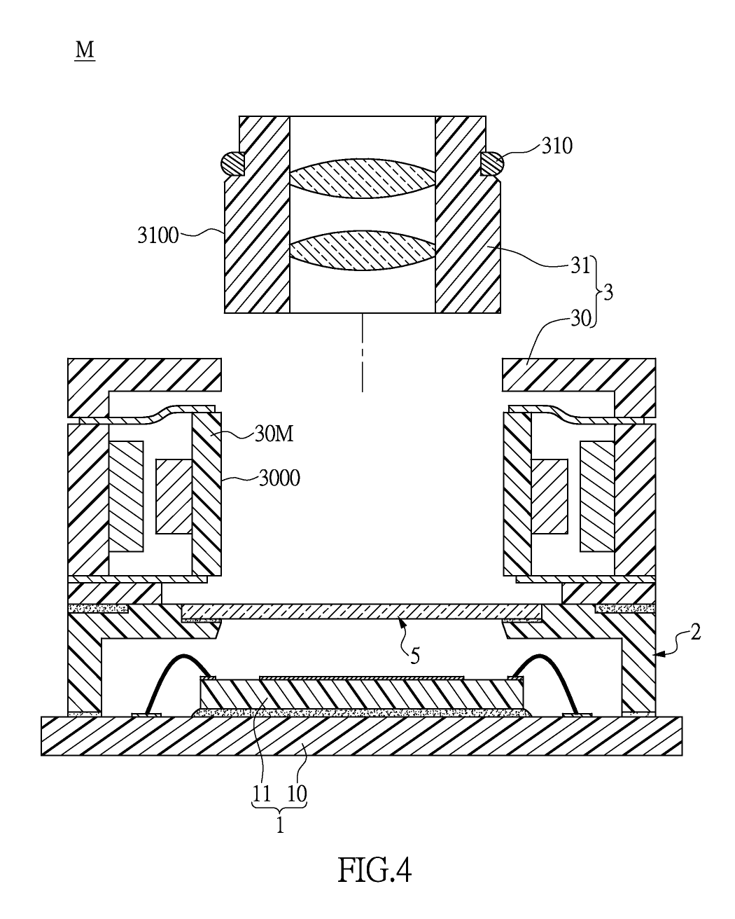

Referring to FIG. 4 to FIG. 6, the second embodiment of the instant disclosure provides an image capturing module M having a built-in flexible dustproof structure, comprising: an image sensing unit 1, a housing frame 2 and an actuator structure 3. The difference between the second embodiment and the first embodiment is as follows: in the second embodiment, the actuator structure 3 includes a lens holder 30 disposed on the housing frame 2 and a movable lens assembly 31 movably disposed inside the lens holder 30, and the movable lens assembly 31 has a flexible ring 310 formed by double injection molding (over-molding) and partially embedded into the outer perimeter surface 3100 of the movable lens assembly 31 and abutted against the inner surrounding surface 3000 of the lens holder 30.

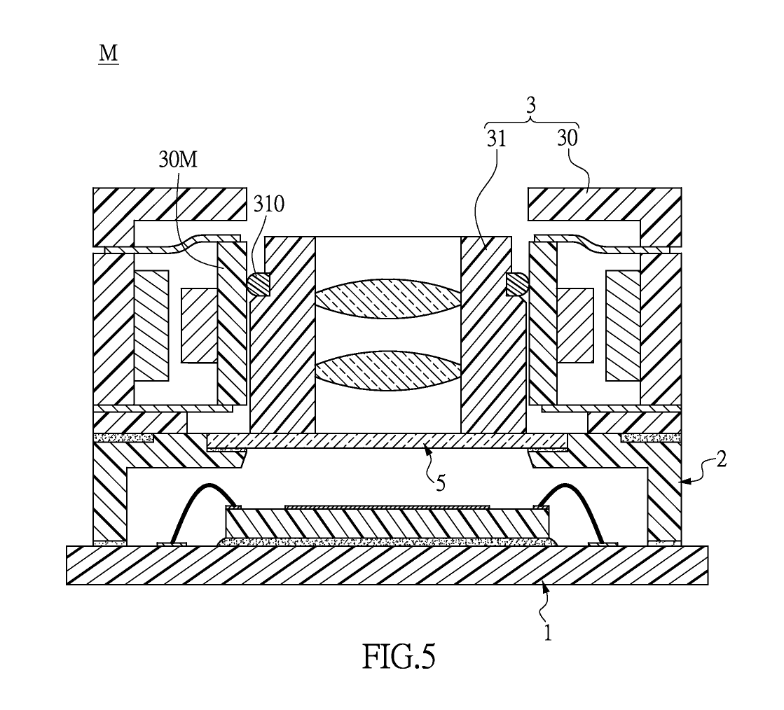

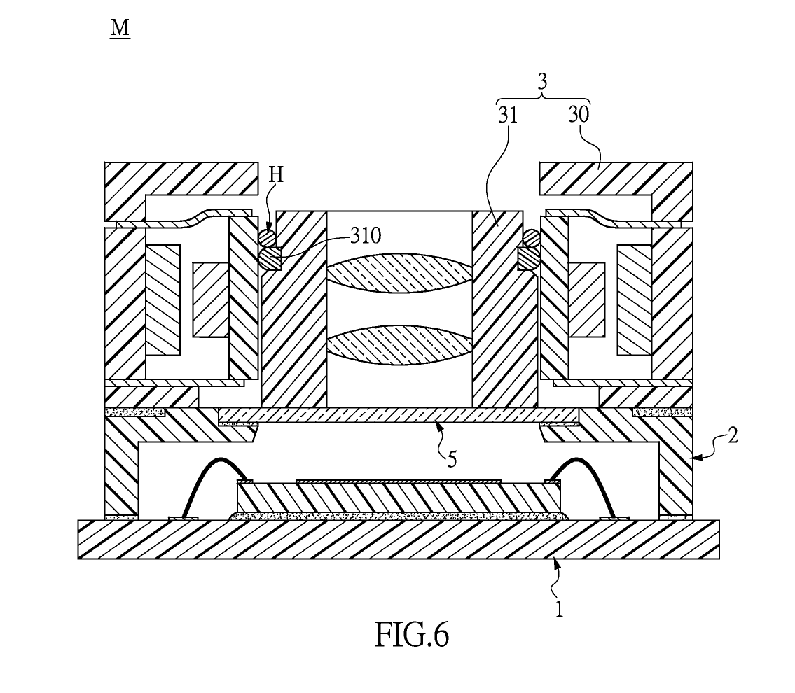

Referring to FIG. 4 and FIG. 5, the flexible ring 310 can be surroundingly fixed on the outer perimeter surface 3100 of the movable lens assembly 31, so that when the movable lens assembly 31 is placed inside the lens holder 30, flexible ring 310 can be abutted against the inner surrounding surface 3000 of the lens holder 30 and the flexible ring 310 can follow the movable lens assembly 31 to move inside the lens holder 30 (i.e., both the flexible ring 310 and the movable lens assembly 31 can be concurrently moved inside the lens holder 30). Therefore, the movable lens assembly 31 is still movable due to the flexible ring 310. For example, the flexible ring 310 may be a O-ring made of rubber material, and both the inner surrounding surface 3000 of the lens holder 30 and the outer perimeter surface 3100 of the movable lens assembly 31 are thread surfaces or threadless (or unthreaded) surfaces (i.e., without any thread or screw on the inner surrounding surface 3000 and the outer perimeter surface 3100). As shown in FIG. 6, when the movable lens assembly 31 is upwardly or downwardly moved to a predetermined correction position, the movable lens assembly 31 and the flexible ring 310 can be fixed inside the surrounding movable member 30M through at least two separate bonding glue H, thus the movable lens assembly 31 can be movably disposed inside the lens holder 30 through the surrounding movable member 30M

Whereby, when the external dust passes through the gap between the inner surrounding surface 3000 of the lens holder 30 or the surrounding movable member 30M and the outer perimeter surface 3100 of the movable lens assembly 31 to get into the actuator structure 3, the external dust is obstructed by the flexible ring 310 that is surroundingly disposed between the inner surrounding surface 3000 of the lens holder 30 and the outer perimeter surface 3100 of the movable lens assembly 31.

### Third Embodiment

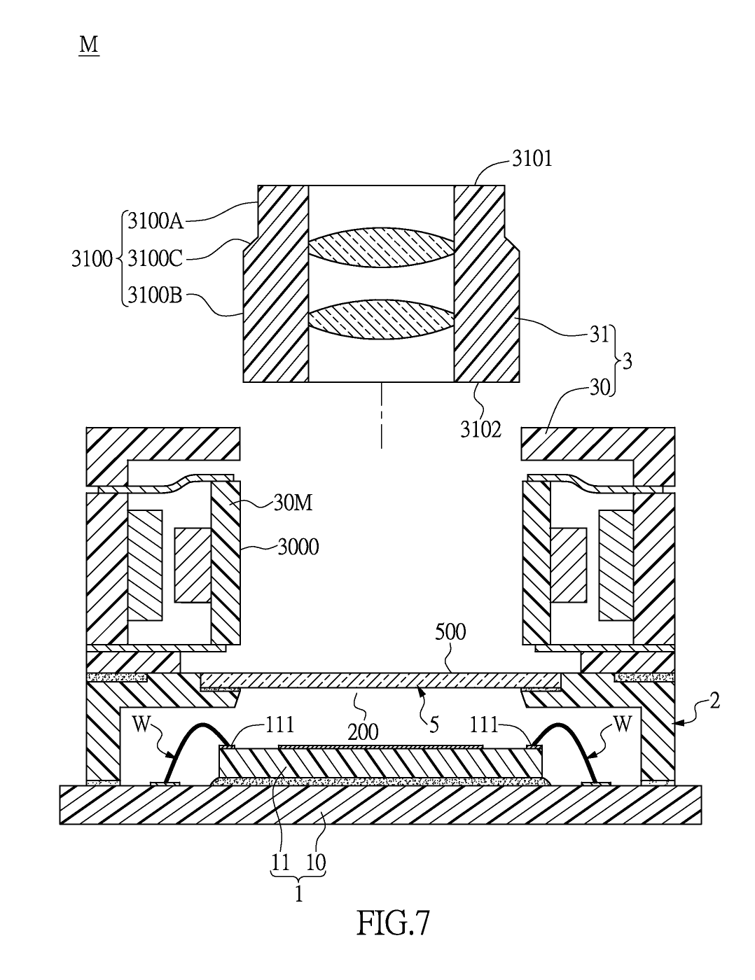

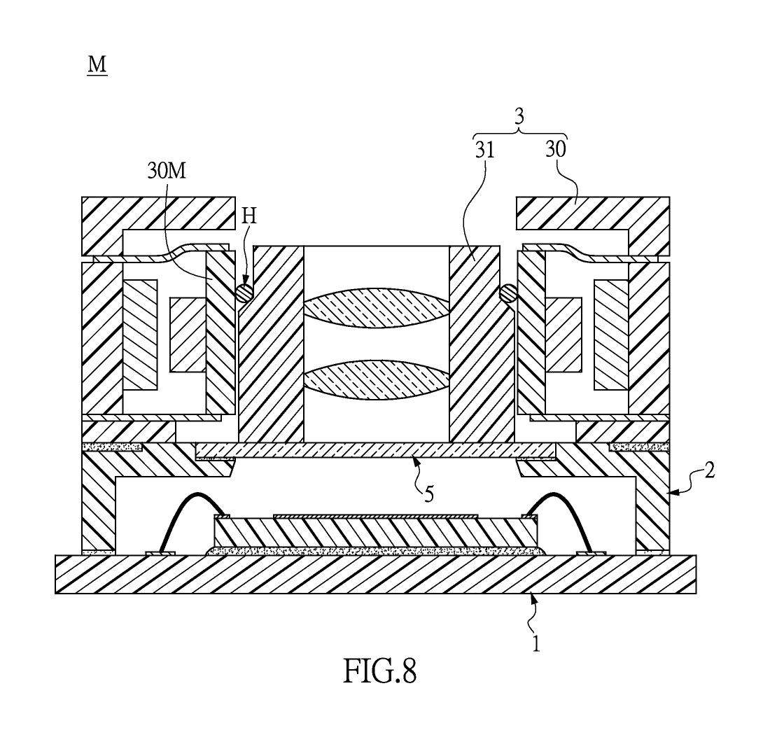

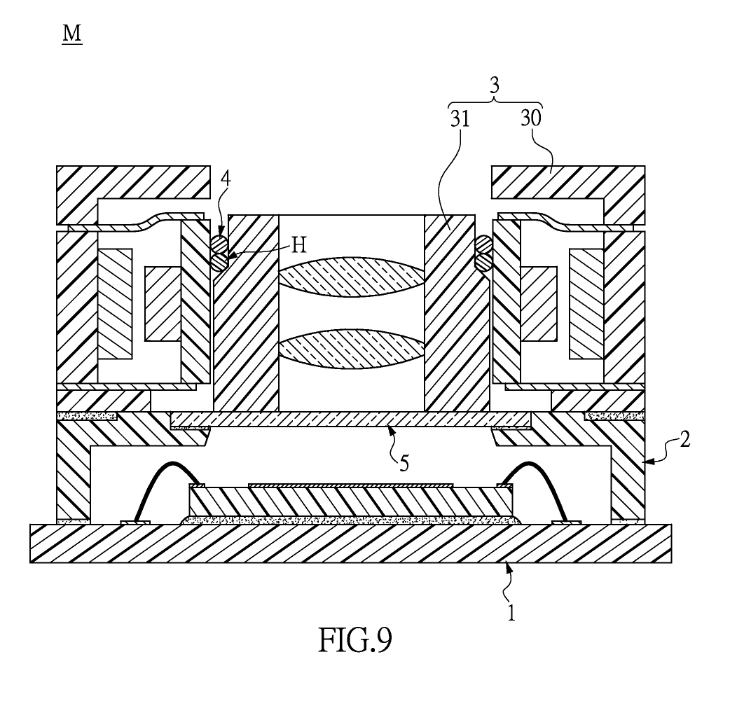

Referring to FIG. 7 to FIG. 9, the third embodiment of the instant disclosure provides an image capturing module M having a built-in flexible dustproof structure, comprising: an image sensing unit 1, a housing frame 2, an actuator structure 3 and a flexible ring 4. The difference between the third embodiment and the first embodiment is as follows: in the third embodiment, when the movable lens assembly 31 is placed inside the lens holder 30, the movable lens assembly 31 can be fixed inside the surrounding movable member 30M through at least two separate bonding glue H, thus the movable lens assembly 31 can be movably disposed inside the lens holder 30 through the surrounding movable member 30M. Referring to FIG. 8 and FIG. 9, after fixing the movable lens assembly 31 inside the surrounding movable member 30M through at least two separate bonding glue H, the flexible ring 4 can be disposed around the outer perimeter surface 3100 of the movable lens assembly 31 and abutted against the inner surrounding surface 3000 of the lens holder 30 to form the built-in flexible dustproof structure.

Whereby, when the external dust passes through the gap between the inner surrounding surface 3000 of the lens holder 30 or the surrounding movable member 30M and the outer perimeter surface 3100 of the movable lens assembly 31 to get into the actuator structure 3, the external dust is obstructed by the flexible ring 310 that is surroundingly disposed between the inner surrounding surface 3000 of the lens holder 30 and the outer perimeter surface 3100 of the movable lens assembly 31.

In conclusion, because the flexible ring 4 is disposed around the outer perimeter surface 3100 of the movable lens assembly 31 and abutted against the inner surrounding surface 3000 of the lens holder 30, the flexible ring 4 can be surroundingly disposed between the inner surrounding surface 3000 of the lens holder 30 and the outer perimeter surface 3100 of the movable lens assembly 31 to form the built-in flexible dustproof structure. Alternatively, because the movable lens assembly 31 has a flexible ring 310 formed by double injection molding (over-molding), the flexible ring 310 can be surroundingly fixed on the outer perimeter surface 3100 of the movable lens assembly 31 and abutted against the inner surrounding surface 3000 of the lens holder 30 to form the built-in flexible dustproof structure. Whereby, when the external dust passes through the gap between the inner surrounding surface 3000 of the lens holder 30 or the surrounding movable member 30M and the outer perimeter surface 3100 of the movable lens assembly 31 to get into the actuator structure 3, the external dust is obstructed by the flexible ring (4 or 310) that is surroundingly disposed between the inner surrounding surface 3000 of the lens holder 30 and the outer perimeter surface 3100 of the movable lens assembly 31.

The aforementioned descriptions merely represent the preferred embodiments of the instant disclosure, without any intention to limit the scope of the instant disclosure which is fully described only within the following claims. Various equivalent changes, alterations or modifications based on the claims of instant disclosure are all, consequently, viewed as being embraced by the scope of the instant disclosure.

1. (canceled)

2. (canceled)

3. (canceled)

4. (canceled)

5. An image capturing module having a built-in flexible dustproof structure, comprising:
an image sensing unit including a carrier substrate and an image sensing chip disposed on the carrier substrate and electrically connected to the carrier substrate;
a housing frame disposed on the carrier substrate to surround the image sensing chip;
an actuator structure disposed on the housing frame and above the image sensing chip, wherein the actuator structure includes a lens holder disposed on the housing frame and a movable lens assembly movably disposed inside the lens holder, and the lens holder includes a surrounding movable member movably disposed therein; and
a flexible ring disposed around an outer perimeter surface of the movable lens assembly and abutted against an inner surrounding surface of the surrounding movable member of the lens holder;
wherein the movable lens assembly and the flexible ring are concurrently fixed inside and on the surrounding movable member through at least one bonding glue, the at least one bonding glue is connected among the movable lens assembly, the flexible ring, and the surrounding movable member, and the movable lens assembly is movably disposed inside the lens holder through the surrounding movable member;
wherein the flexible ring is surroundingly disposed between the inner surrounding surface of the surrounding movable member of the lens holder and the outer perimeter surface of the movable lens assembly to form the built-in flexible dustproof structure.

6. The image capturing module of claim 5, further comprising: an optical filter disposed on the housing frame and between the image sensing chip and the movable lens assembly, wherein the housing frame has a top opening disposed on the top side thereof and between the image sensing chip and the movable lens assembly, and the top opening of the housing frame is enclosed by the optical filter, wherein the movable lens assembly and the flexible ring are concurrently fixed inside and on the surrounding movable member through another bonding glue that is separated from the at least one bonding glue.

7. The image capturing module of claim 6, wherein both the inner surrounding surface of the surrounding movable member of the lens holder and the outer perimeter surface of the movable lens assembly are threadless surfaces, and the movable lens assembly is disposed on the top surface of the optical filter, thus the bottom side of the movable lens assembly directly contacts the top side of the optical filter.

8. The image capturing module of claim 6, wherein the outer perimeter surface of the movable lens assembly is divided into a first surrounding surface adjacent to the top side of the movable lens assembly, a second surrounding surface adjacent to the bottom side of the movable lens assembly, and a third surrounding surface connected between the first surrounding surface and the second surrounding surface, and the flexible ring is movably disposed around the first surrounding surface and abutted against the third surrounding surface.

9. An image capturing module having a built-in flexible dustproof structure, comprising:
an image sensing unit including a carrier substrate and an image sensing chip disposed on the carrier substrate and electrically connected to the carrier substrate;
a housing frame disposed on the carrier substrate to surround the image sensing chip; and
an actuator structure disposed on the housing frame and above the image sensing chip, wherein the actuator structure includes a lens holder disposed on the housing frame and a movable lens assembly movably disposed inside the lens holder, the movable lens assembly has a flexible ring surroundingly fixed on an outer perimeter surface thereof by double injection molding and abutted against an inner surrounding surface of the lens holder, and the lens holder includes a surrounding movable member movably disposed therein;
wherein the movable lens assembly and the flexible ring are concurrently fixed inside and on the surrounding movable member through at least one bonding glue, the at least one bonding glue is connected among the movable lens assembly, the flexible ring, and the surrounding movable member, and the movable lens assembly is movably disposed inside the lens holder through the surrounding movable member.

10. The image capturing module of claim 9, further comprising: an optical filter disposed on the housing frame and between the image sensing chip and the movable lens assembly, wherein the housing frame has a top opening disposed on the top side thereof and between the image sensing chip and the movable lens assembly, and the top opening of the housing frame is enclosed by the optical filter, wherein both the inner surrounding surface of the lens holder and the outer perimeter surface of the movable lens assembly are threadless surfaces, and the movable lens assembly is disposed on the top surface of the optical filter, thus the bottom side of the movable lens assembly directly contacts the top side of the optical filter.

11. The image capturing module of claim 9, wherein the movable lens assembly and the flexible ring are concurrently fixed inside and on the surrounding movable member through another bonding glue that is separated from the at least one bonding glue.
